(19) United States
(12) Patent Application Publication
(10) Pub. No.: US 2008/0052142 A1
(43) Pub. Date: Feb. 28, 2008

(54) SYSTEM AND METHOD FOR REAL-TIME DISPLAY OF EMERGENCIES, RESOURCES AND PERSONNEL

(76) Inventors: Maurice Gerald Thomas Bailey, Los Gatos, CA (US); Roman Smolgovsky, Foster City, CA (US); Katy Ngoc-Binh Ly, Toronto (CA)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/684,636

(22) Filed: Mar. 12, 2007

Related U.S. Application Data
(60) Provisional application No. 60/782,135, filed on Mar. 13, 2006.

(51) Int. Cl. G06Q 10/00

(52) U.S. Cl. 705/8

(57) ABSTRACT

A system and method displays real-time incidents and resources on a map and/or in a report to enable incident commanders to view and allocate resources accordingly.

### PRIORITY REFERENCE TO PRIOR APPLICATIONS

This application claims benefit of and incorporates by reference U.S. patent application Ser. No. 60/782,135, entitled “Surface Logistics,” filed on Mar. 13, 2006, by inventors Maurice Gerald Thomas Bailey et al.

### TECHNICAL FIELD

This invention relates generally to logistics displays, and more particularly, but not exclusively, provides a system and method for real-time graphical display of emergency incidents and resources on a map.

### BACKGROUND

Emergency response involves quick and confident thinking—decisive action can be a fine line between life and death. In any environment, a sound decision requires real-time situational awareness of the incident and facilities surrounding the event to coordinate response across divisions, facilities and business units.

Further, sound decision making requires real-time knowledge of other emergencies that could require resources so that resources can be allocated quickly and efficiently to emergencies.

Accordingly, a new system and method are needed that displays real-time incident data and emergency response resources data.

### SUMMARY

In an embodiment, the system and method include a real-time situation management tool for an emergency response commander to easily identify and track incidents in real-time, recognize the perimeter risk tolerance, and to allocate resources or personnel as needed, and to share and communicate this information to other users or generate notifications and alerts for evacuation.

In an embodiment, the system is a browser-based application with real-time graphical and report presentations of the active incidents and iconic representations of the resources availability and movement from nearby facilities (such as fire stations, police stations and ambulance posts) to the incidents as the events unfold. In an embodiment, the system is accessible remotely or locally in a response center using wired or wireless connection through a secure portal. Critical data points can be examined from a bird's-eye view or to drill down to a specific incident. The data may include the information about high priority 911 incidents, incidents management effort, stations/posts of duty information, missions and personnel locations, etc.

In an embodiment, the system and method enables authorities from agencies who are responding to an emergency to collaborate virtually. The commanders of different emergency centers will share the same views in real-time. One commander will see the dispatching status of the unit, while the other sees the changing status of the unit in the receiving end.

In an embodiment, the method comprises: displaying a map with an incident thereon; determining resources within map boundaries; determining status of the resources; and displaying the resources with status on the map.

In an embodiment, the system comprises a resource engine, a mission engine, and a graphical user interface. The resource engine determines resources within boundaries of a map. The mission engine the status of the resources. The GUI displays the map with an incident thereon and displays the resources with status on the map.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an emergency incident and response system;

FIG. 2 is a block diagram illustrating an example computer for use with components of the system of FIG. 1;

FIG. 3 is a block diagram illustrating a processor of the system of FIG. 1;

FIG. 4 is a block diagram illustrating a database of the processor of FIG. 3;

FIG. 5 is a diagram illustrating an example output of the system;

FIG. 6 is a diagram illustrating an example output of the system; and

FIG. 7 is a flowchart illustrating a method of generating and outputting emergency incident and response resources data.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

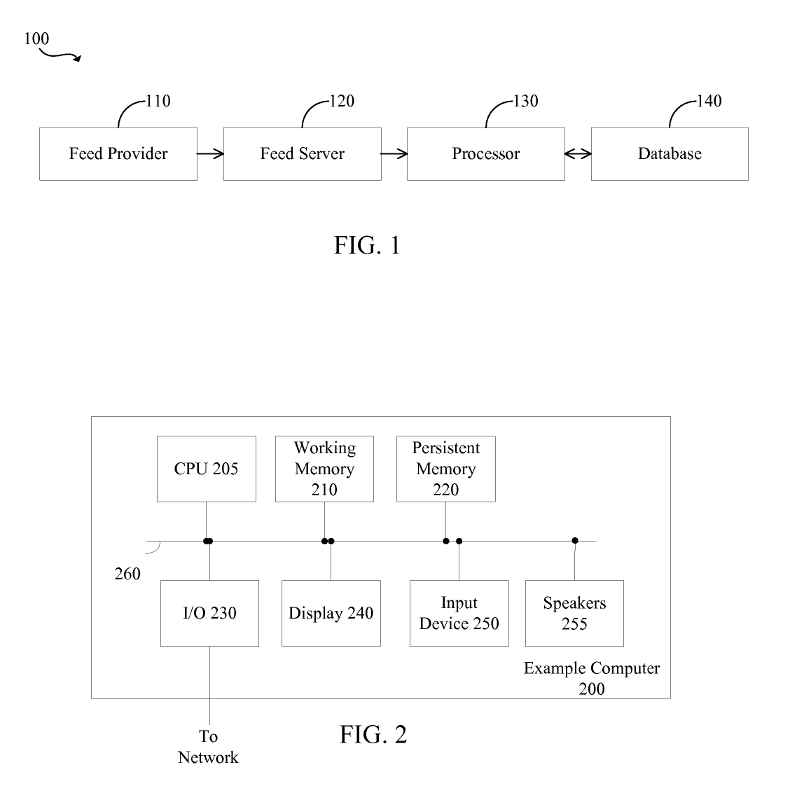

FIG. 1 is a block diagram illustrating an emergency incident and response system 100. The system 100 provides real-time situational awareness to emergency response commanders to make quick and sound decision in order to respond to emergency or emergency-related activity in their area.

The system 100 provides continuous real-time updates of the relevant incidents and tracking of the facilities status in relevant area as the events unfold. As the incident continues to unfold, a response team must be vigilant of the active events that happen around them and the resources availability that can be acquired at time of need. To determine the degree of threat and the best course of action for the incident, emergency response commanders must have real-time and up-to-date information of the on-going activities of the incident and the nearby facilities, to call for required medical aids and special units or resource reinforcement. The system 100 offers the capability to track an incident or a set of incidents and the nearby resources in real-time; comprises different graphical and report presentations, from a bird's-eye view to drill down detail of the emergency or the facilities' activities.

The system 100 enables real-time tracking of the resource availability and movement to or from the incident locations. Emergency scenarios don't happen in “ideal” situations, because of many variables and possibilities for roadblocks, dispatched resources may not reach the incident site in a timely manner. Either because of traffic jam or impact of another nearby incident, delayed arrival of the resources or important personnel may cost lives and financial loss. The system 100 offers a solution to geo-locate the moving asset (such as fire truck, police car or ambulance) and provide a mechanism to communicate to the operators, either regionally or interoperate from another region. Knowing that the resources will not get there within the expected timeframe, another unit can be assigned to the incident site, avoiding the obstacles as encounter by the prior assignees.

The system 100 meets distinct needs of different user types by differing in the level of details. While emergency response commanders such as incident managers and coordinators will drill down to the detail of an incident, a high-level view to see the “big picture” may be sufficient for the executive team and the media. Users who manage or coordinate response across facilities will require the ability to access the critical data in both the bird's-eye view and the flexibility to drill down to the details as well as to examine movement of the critical data in tabular formats for impact assessment. Executive team and the media may simply interest in the bird's-eye view of the situation.

Users of the system 100 may include an observer; an executive; a coordinator/manager; and an administrator. An observer is not directly involved in the situation, but may receive certain limited information about it. For example Media can view the local incidents in the area without seeing the exact Incident handling details such as units allocated for incidents management, location of the emergency management stations, available equipment, etc.

An executive is indirectly involved in the situation. As the result, Executive is not interested in particular details, but needs to see the ‘big’ picture. This user receives the summary information about the current situation and the high-level view.

A coordinator/manager is directly involved with the situation. This user is expected to make the decisions about its handling—high-level of details is required. In order to effectively manage the situation, the user may decide to filter out all the data that is not relevant at the moment—concentrate on a particular area, select particular stations, look a certain incidents, etc. User may use relevant information to coordinate response activities across division, facilities and business unit, and possibly to communicate information to media and outside agencies.

An administrator manages the users in the system and their access to the data.

The system 100 generates notification to alert key parties, in case of mandatory evacuation is required. In a high-risk emergency situation, timing is important. Having direct access to the incident updates and tracking of the facilities status and their units' availability, emergency response commanders can notify and alert key parties, nearby facilities and the local communities to be vigilant of the situation and evacuate if required. The system 100 offers a mechanism to import and lookup the contact rosters at the commander's fingertip.

The system 100 includes a feed provider 110, a feed server 120, a processor 130 and a database 140. The elements of system 100 can be interconnected to each other via a network, such as the Internet. In an embodiment, the feed provider 110 communicates only with the feed server 120, which in turn communicates with the processor 130 and the database 140. In an embodiment of the invention, the feed server 120, the processor 130 and the database 140 are combined into a single element of the system 100.

The feed provider 110 provides incident and resource information to the feed server 120, which provides it to the processor 130 for processing and storing the in the database 140. The processor 130 also outputs processed incident and resource information in a map overlay and/or in a report format, as will be discussed further below.

In an embodiment, dynamic feed is received as a stream of ASCII text strings sent by the feed provider 110 via HTTP to a specified port. The HTTP exchange can be implemented through TCP/IP sockets for reliable content delivery.

Upon establishing the successful TCP/IP connection between the feed provider 110 and the feed server 120, the feed provider 110 sends the ASCII text messages. After the connection is established, the feed provider 110 authenticates itself with the server 120 by providing the login and password hash (not a real password) that is compared by the server with the credentials stored in the database.

The feed provider 110 periodically sends the data messages that are parsed and processed by the server 120. During the periods of inactivity the feed provider periodically sends heartbeat messages to the server 120. The server will terminate the data exchange session if the server 120 does not receive any emergency data or heartbeat messages for a long period of time (e.g., 1 hour). The feed provider 110 can gracefully end the session by sending a quit message to the feed server 120.

FIG. 2 is a block diagram illustrating an example computer 200 capable of housing any of the elements of the system 100. The system 100 includes a central processing unit (CPU) 205; a working memory 210; a persistent memory 220; an input/output (I/O) interface 230; a display 240 (e.g., LCD); an input device 250; and speakers 255; all communicatively coupled to each other via a bus 260. The CPU 205 may include an ARM 7 microprocessor, INTEL PENTIUM processor or any other processor capable to execute software stored in the persistent memory 220. The working memory 210 may include random access memory (RAM) or any other type of read/write memory devices or combination of memory devices. The persistent memory 220 may include a hard drive, a FLASH memory, a read only memory (ROM) or any other type of memory device or combination of memory devices that can retain data after the computer 200 is shut off. The I/O interface 230 sends and receives data via a network or direct connection to other elements of the system 100.

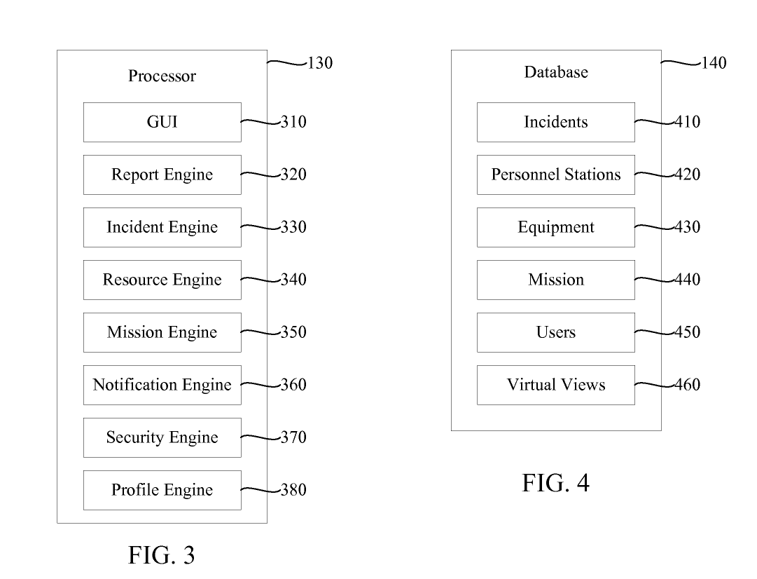

FIG. 3 is a block diagram illustrating the processor 130 of the system 100. The processor 130 includes a graphical user interface (GUI) 310; a report engine 320; an incident engine 330; a resource engine 340; a mission engine 350; a notification engine 360; a security engine 370; and a profile engine 380. The components of the processor 130 can be implemented as software, application specific integrated circuits (ASICs) or with other technology.

The GUI 310 is capable of displaying, superimposed on a map, local incidents, personnel stations, equipment, and mission information by retrieving the relevant information from the database 140. Local incidents may be reported by 911 data centers. The information about the incident may contain: Incident ID; Incident Type; Priority; Address; Latitude/Longitude; Equipment involved in handling the incident and/or personnel involved in handling the incident; Location information allows viewing the Picture of the area (satellite, 45 degree view, etc.) if available as well as gives the user any additional information.

Personnel Stations include Fire Houses, Police Precincts, Ambulance Posts, and Federal Agencies Posts of Duty, etc. The information about a station may contain: Station ID; Station Type; Address; Latitude/Longitude; and Equipment and/or personnel assigned to the station and its status.

Equipment includes Fire Trucks, Ambulances, Police vehicles, Helicopters; any Federal Agencies equipment, etc. The information about equipment may contain: Equipment ID; Equipment Type; Mission Identifier (if necessary); Assigned Personnel including personal equipment and training information; Current status and availability (off-line, ready, en-route to the incident, arrived at the scene, enroute to the station); Additional equipment information (mutual aid, etc.); Latitude/Longitude (if necessary); Station the unit belongs to; Station assignment; Incident assignment; Textual information about home quarters; Textual information about unit equipment; and Personnel Info.

Mission information allows identifying the exact location of the personnel involved in the mission; this information may be important to handle logistics of the mission or deal with the incidents management. The information about the personnel may include the following information: Personnel Info (First/Last Name); Mission Identifier (if necessary); Exact location latitude/longitude position of the mission; Skills/Training information of the personnel; Personal/Mission equipment information; and Location information allows viewing the Picture of the area (satellite, 45 degree view, etc.) if available as well as gives the user any additional information.

A user of the system 100 can also specify layers to be displayed on a map by the GUI 310. Layers include: Fire Stations; Police Stations; Ambulance Posts; Incidents; and custom-defined events, etc. A user can view resource activities in different levels depending on the magnitude of the emergency; navigation of the view can start from local, operational area by county, region, inter-region, state and national regions. The user also has the capability to zoom into the detail of a specific unit or zoom out to see activities of the Emergency Operational Centers. A user can track a specific incident and their resources (equipment or personnel) as they are allocated to the incident. A user can track the movement and availability of assets (e.g., fire truck, ambulance etc) at station level such as: Station details: location, station type and contact information; and Asset availability and dispatched status that are specific to the incident.

A user can track movement and availability of assets at equipment detail level. A user can track movement and availability of personnel for the incidents of at the station at personnel detail level: Perform on-duty assignment capabilities; and Track an individual or an entire units and progress from the station to the incident.

A user can track assets activities of stations at city, county or state levels in response to their active incidents in their coverage area.

Alternatively, the report engine 320 can provide the above information in tabular format instead of in graphical format on a map.

The incident engine 330 parses incident data from the feed server 120 and populates and/or updates incidents 410 in the database 140. Similarly, the resource engine 340 parses resource data from the feed server 120 and populates and/or updates personnel stations 420; equipment 430; and mission 440 in the database 140. The mission engine 350 parses mission data received from the feed server 120 and populates and/or updates mission 440.

The notification engine 360 generate notifications to alert key parties, in case of mandatory evacuation is required. For example, a chemical spill incident may necessitate evacuation of nearby homes and businesses. In an embodiment, the notification engine 360 automatically generates and transmits a notification based on incident type. In another embodiment, the notification engine 360 generates a notification based on incident type but does not transmit the notification until authorization is received from an appropriate user.

The security engine 370 authenticates users using users data 450 in the database 140. In an embodiment, access can be either over a wired or wireless network, into the system 100. In an embodiment, users are required to identify themselves, using RSA secure ID, before entering the system 100 and the data sent over the network will encrypted to protect its sensitivity.

The profile engine 380, using virtual views 460 in the database 140, enables a user to call up virtual views of the emergency area, such to access digital blueprints of a high-profile building, view 3-D images of a region and view satellite image of the region. Availability of the digit blueprint can help incident commanders to navigate around the incident area and arrive to safety zones.

The database 140 includes data for use by the GUI 310; the report engine 320; the notification engine 360; and the security engine 370. The database 140 includes incidents 410; personnel stations 420; equipment 430; mission 440; users 450; and virtual views 460.

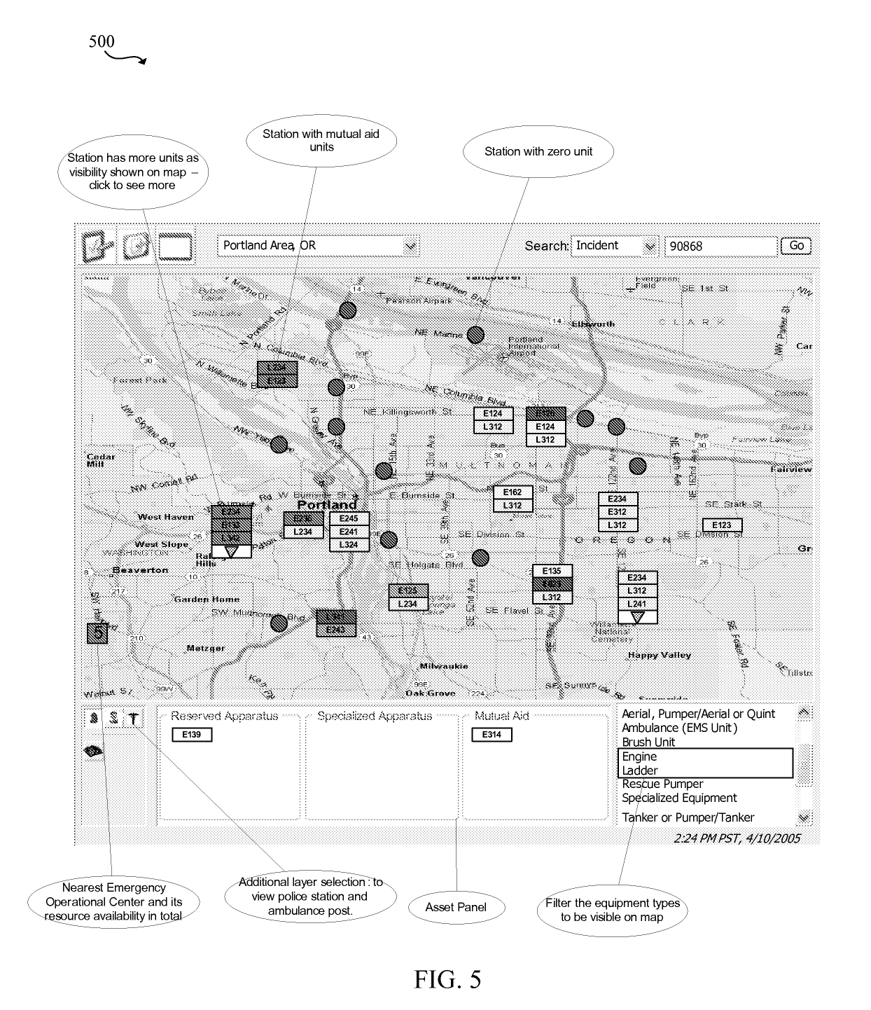

FIG. 5 is a diagram illustrating an example output 500 of the system 100, specifically, an Incident Management Panel, which provides geographical and topographical views of the local incident, its nearest stations and their resource activities.

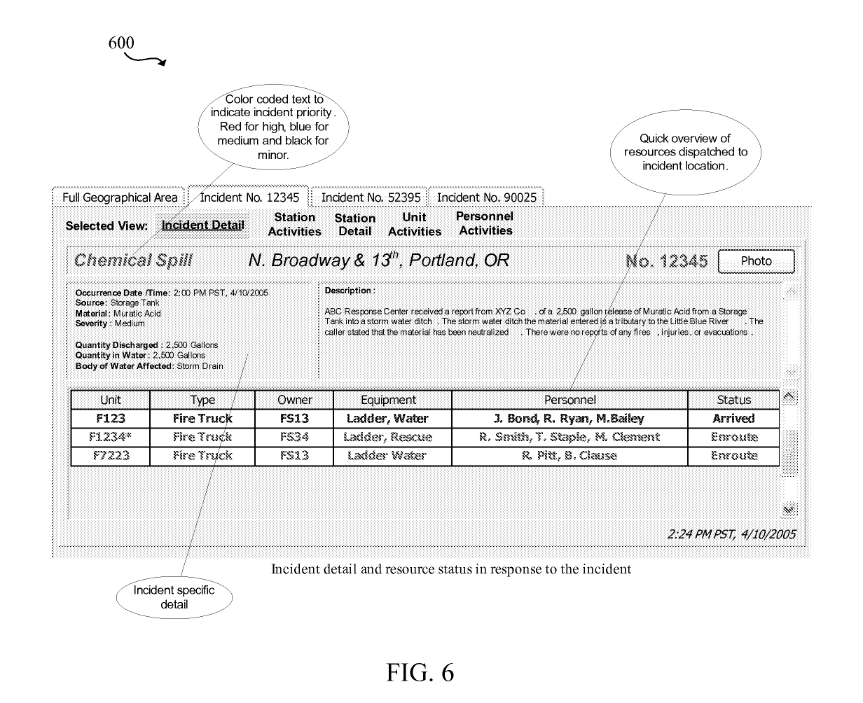

FIG. 6 is a diagram illustrating an example output 600 of the system 100, specifically, a Report Panel that provides incident and its nearest station activities in tabular report format.

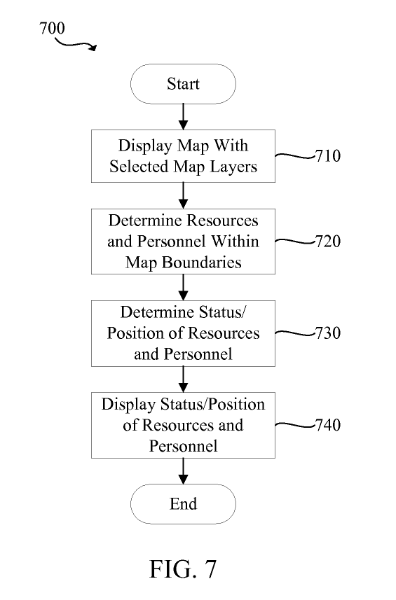

FIG. 7 is a flowchart illustrating a method 700 of generating and outputting emergency incident and response resources data. First, a map is displayed (710) with selected layers based on a selected incident (e.g., region surrounding an incident) or level (e.g., city, state, nation, etc.) with incident(s) thereon. Then, resources (e.g., equipment; stations; etc.) and personnel within the map boundaries are determined (720). The status and position of the resources and personnel are then determined (730). The status and position of the resources and personnel are then display (740) on the map (e.g., resources and personnel are positioned on the map corresponding to their position and/or location of same are printed on the map). The method 700 then ends.

The foregoing description of the illustrated embodiments of the present invention is by way of example only, and other variations and modifications of the above-described embodiments and methods are possible in light of the foregoing teaching. For example, resources can include resources of any type, including emergency medical and food supplies. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
displaying a map with an incident thereon;
determining resources within map boundaries;
determining status of the resources; and
displaying the resources with status on the map.

2. The method of claim 1, further comprising:
determining personnel within map boundaries;
determining status of the personnel; and
displaying the personnel with status on the map.

3. The method of claim 1, further comprising:
continuously updating the status of the determined resources; and
displaying the resources with updated status on the map when there is a change in status.

4. The method of claim 1, further comprising:
determining if a notification should be sent based on the incident; and
transmitting the notification based on the determining if a notification should be sent.

5. The method of claim 1, further comprising generating a report in tabular format listing an incident and resources dispatched to the incident.

6. The method of claim 1, further comprising:
determining resources assigned to an incident; and
indicating on the map the assignments of the displayed resources.

7. The method of claim 1, further comprising displaying virtual views related to an incident.

8. The method of claim 1, wherein the resources includes personnel stations and equipment.

9. A system, comprising:
means for displaying a map with an incident thereon;
means for determining resources within map boundaries;
means for determining status of the resources; and
means for displaying the resources with status on the map.

10. A computer-readable medium having stored thereon instructions to cause a computer to execute a method, the method comprising:
displaying a map with an incident thereon;
determining resources within map boundaries;
determining status of the resources; and
displaying the resources with status on the map.

11. A system, comprising:
a resource engine for determining resources within boundaries of a map;
a mission engine for determining status of the resources; and
a GUI for displaying the map with an incident thereon and for displaying the resources with status on the map.

12. The system of claim 11, further comprising:
a personnel engine for determining personnel within map boundaries;
wherein the mission engine is further for determining status of the personnel; and
wherein the GUI is further for displaying the personnel with status on the map.

13. The system of claim 1 1, wherein the mission engine is further for continuously updating the status of the determined resources; and
wherein the GUI is further for displaying the resources with updated status on the map when there is a change in status.

14. The system of claim 11, further comprising:
a notification engine for determining if a notification should be sent based on the incident and transmitting the notification based on the determining if a notification should be sent.

15. The system of claim 11, further comprising a report engine for generating a report in tabular format listing an incident and resources dispatched to the incident.

16. The system of claim 11, wherein the mission engine is further for determining resources assigned to an incident; and wherein the GUI is further for indicating on the map the assignments of the displayed resources.

17. The system of claim 11, further comprising a profile engine for displaying virtual views related to an incident.

18. The system of claim 11, wherein the resources includes personnel stations and equipment.
